(19) United States
(12) Patent Application Publication
(10) Pub. No.: US 2007/0150571 A1
(43) Pub. Date: Jun. 28, 2007

(54) System, method, apparatus and program for event processing

(76) Inventors: Futoshi Haga, Sagamihara (JP); Yutaka Kudo, Yokohama (JP); Tomohiro Morimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/471,480

(22) Filed: Jun. 21, 2006

(30) Foreign Application Priority Data
Dec. 8, 2005 (JP) 2005-354487
Mar. 31, 2006 (JP) 2006-096405

(51) Int. Cl. G06F 15/173

(52) U.S. Cl. 709/223

(57) ABSTRACT

An event processing system that can perform processing corresponding to event messages certainly, and improve efficiency of processing event messages.

To that end, the event processing system of the present invention holds event messages, which are received owing to state transitions of an IT service system, in an event message holding unit in order of issue. Among the event messages held in the event message holding unit, the event processing system searches for an event message for which a state of the IT service system after issue of the event message in question coincides with a state of the IT service system before issue of the oldest event message in the event message holding unit. When the event processing system can retrieve the event message in question, the event processing system deletes event messages ranging from the oldest event message to the retrieved event message from the event message holding unit.

### BACKGROUND OF THE INVENTION

1. Field of the Invention

The present invention relates to a system and method of processing an event message that is outputted according to a transition of a state of a monitored object.

2. Description of the Prior Art

A recent IT system is becoming a large-scale and complex one, for example, including a plurality of IT devices, and frequently an event-driven system is employed for managing operation of such an IT system. In an event-driven IT management system, a plurality of monitoring systems monitor dynamic management information such as fault information, performance information, state transition and the like of monitored IT devices. When a significant change occurs in the management information, a monitoring system recognizes it as an event and sends an event message to its own or another IT management system. When an IT management system receives an event message, the IT management system usually performs suitable processing according to the received event message, to carry out its operation management work smoothly.

For example, in a large scale computer center, a system is constructed such that each of a plurality of business applications such as Web service programs is executed on one or more computers, and requests to a business application are distributed into the computers on which that business application is executed.

In such a system, quantity of resource (computer resource) is decreased or increased in order to process smoothly a business application having a large number of requests. In other words, computers to which no business application is assigned are put on standby. And, a business application having a large number of processing requests is assigned a standby computer so that the computer executes the business application in question and those processing requests are dealt with.

Patent Document 2 (Japanese Non-examined Patent Laid-Open No. 2005-141605) discloses a technique of reassigning a computer resource on which a certain service (a business application) is operated to another service. According to the disclosed technique, a standby computer resource has a dead standby state in which an application is not installed. Such computer resources in the dead standby state are shared by a plurality of services or a plurality of users in order to improve the activity ratio of idle computer resources and in order to realize integration of servers, thus reducing costs required for maintaining the computer resources. Further, respective loads of services are estimated by using their past operation histories, and then an idle computer resource held by a service of excessive capacity is relocated to another service, based on the estimation results.

As a result, the service level of a business application having many processing requests is prevented from declining. Here, the service level means the level of service provided from a service provider to service users. For example, a service level is expressed by the time elapsed from sending of a request from a terminal of a service user until reception of a response to that request by the terminal.

An event-driven management method is used also for managing the above-mentioned large scale IT system. In the above example, in order to specify a business application having a large number of processing requests, a performance monitoring program is installed in one or more computers on which business applications are executed, to monitor computer resources of those computers and performance and states of the business applications executed on those computers. When a measurement (the number of processing requests, service level, load or the like) on a monitored object exceeds a predetermined threshold, the performance monitoring program sends an event message to an IT management system to notify the IT management system of the fact. Thus, by increasing or decreasing quantities of resources (computer resources) assigned to business applications, it is possible to execute smoothly a business application having a large number of processing requests.

In such an event-driven IT management system, sometimes the processing capacity of the management system becomes deficient and its processing is delayed when the number of event messages becomes huge.

As a technique for solving the problem, Patent Document 1 (Japanese Non-examined Patent Laid-Open No. 2004-287755) discloses a technique in which time stamps of event messages remaining in an event queue are compared, and only event messages that have notified at intervals of longer times than a predetermined time become objects of processing in an event processing unit. As a result, processing of event messages successively received in a short period is omitted and high speed processing of event messages is realized.

### SUMMARY OF THE INVENTION

The event control device described in Patent Document 1 indiscriminately discards events on the basis of only time stamps of the events irrespective of contents of the events. Thus, processing of event messages that arrive successively in a short period is omitted, to realize high speed processing of events. As a result, sometimes the event control device discards events that should be treated, and the system as a whole can not operate properly.

In other words, in an IT management system where computer resources assigned to business applications are dynamically adjusted depending on the service levels of those business applications, sometimes event messages indicating resource increase or decrease occur frequently in a short period in comparison with a time required for processing of increasing or decreasing a computer resource. When the event control of Patent Document 1 is employed to cope with such a phenomenon of the system, there is a possibility that increase or decrease of a computer resource required for the system may not be performed.

Event messages may occur frequently in a short period when a threshold of measurement of a monitored object is set inappropriately, when a large number of items are monitored, or when a business application whose load is difficult to estimate, such as a Web service, is operated although a threshold of measurement is set properly. When service level changes, event messages received in those cases have various contents according to types of monitored items. Thus, various kinds of event messages may be received in a short period.

Further, in the case where a change of a computer resource requires a transition time ranging from dozens of minutes (time in minutes) through several hours (time in hours), change operation becomes unstable when event messages requiring conflicting operations of the computer system exist among a plurality of event messages received during the migration time. Thus, the conventional technique described in Patent Document 1 can not cope with these situations, since the technique deals with only event messages concentrated in a short period.

The present invention has been made considering the above situation. And, an object of the present invention is to make it possible to perform proper processing corresponding to an event message certainly and to improve efficiency of processing event messages.

To solve the above object, an event processing system according to the present invention holds event messages issued owing to state transitions of a monitored system, in an event message holding means. Among the event messages held in the event message holding means, the processing system searches for an event message for which a state of the monitored system after issue of the event message in question coincides with a state of the monitored system before issue of the oldest event message stored in the event message holding means. When the event processing system can retrieve the event message in question, the event processing system deletes event messages ranging from the oldest event message to the retrieved event message from the event message holding means.

In other words, the event processing system is furnished with such a function that, for example in the case where the event processing system receives event messages of “CPU utilization: medium”, “CPU utilization: low”, “CPU utilization: medium”, “CPU utilization: high”, “CPU utilization: medium”, and so on after an event message of “CPU utilization: high” (FIG. 5), then the event processing system ignores event messages ranging from the first event message of “CPU utilization: high” to the event message of “CPU utilization: high” appearing for the first time after the first event message, thus suppressing unnecessary operation of changing computer resources.

For example, the present invention provides an event processing system that receives, each time when a state of a monitored system makes a transition, an event message specifying a content of the transition from a monitoring system, and controls the monitored system according to the received event message, wherein: the event processing system comprises: an event message holding means, which holds event messages issued by the monitoring system and outputs the event messages in order of issue; an event processing means, which processes the event messages outputted from the event message holding means, to control the monitored system; and an event filtering means, which selects event messages that should be processed among the event messages in the event message holding means and supplies the selected event messages to the event processing means; and the event filtering means searches the event messages held in the event message holding means for an event message for which a state of the monitored system after issue of the event message coincides with a state of the monitored system before issue of an oldest event message stored in the event message holding means; and when the event filtering means can retrieve the event message in question, the event filtering means performs filtering processing by deleting event messages ranging from the oldest event message to the retrieved event message from the event message holding means.

According to the event processing system of the present invention, it is possible to perform processing corresponding to event messages certainly and to improve the efficiency of processing event messages.

### BRIEF DESCRIPTION OF THE DRAWINGS

FIG. 1 is a diagram showing a configuration of a service providing system 10 according to one embodiment of the present invention;

FIG. 2 is a diagram showing an example of information included in an event message;

FIG. 3 is a diagram showing a detailed functional configuration of an event processing system 23;

FIG. 4 is a diagram showing an example of structure of data stored in an event correspondence table storage unit 230;

FIG. 5 is a conception diagram for explaining an example of event messages issued owing to state transitions of an IT service system 40;

FIG. 6 is a conception diagram for explaining a process in which an event filtering unit 231 deletes event messages;

FIG. 7 is a flowchart showing an example of operation of a monitored object control system 20;

FIG. 8 is a diagram showing an example of structure of data stored in an event message supply unit 21;

FIG. 9 is a diagram showing an example of information held temporarily in an event message queue 22;

FIG. 10 is a conception diagram for explaining a process of acquiring a state of the IT service system 40 prior to issue of the oldest event message among processes in which the event filtering unit 231 deletes event messages;

FIG. 11 is a conception diagram for explaining a process of acquiring a state of the IT service system 40 after issue of a selected event message among processes in which the event filtering unit 231 deletes event messages; and

FIG. 12 is a diagram showing an example of a hardware configuration of the monitored object control system 20 or the like.

### DESCRIPTION OF THE PREFERRED EMBODIMENTS

Now, embodiments of the present invention will be described.

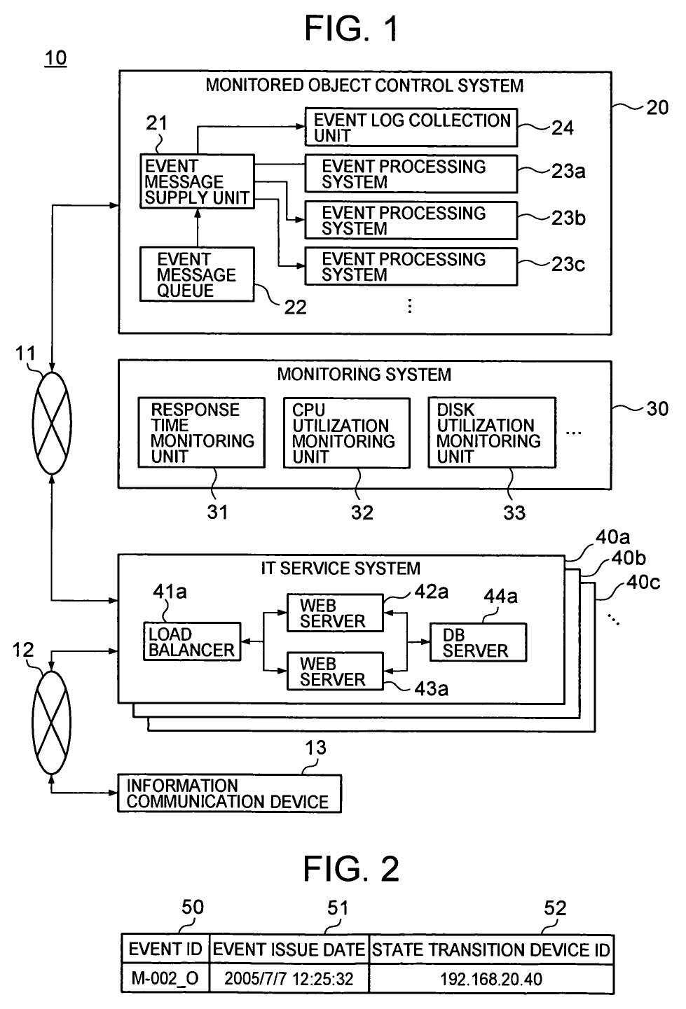

FIG. 1 shows a configuration of a service providing system 10 according to one embodiment of the present invention. The service providing system 10 comprises a monitored object control system 20, a monitoring system 30, and a plurality of IT service system 40a-40c.

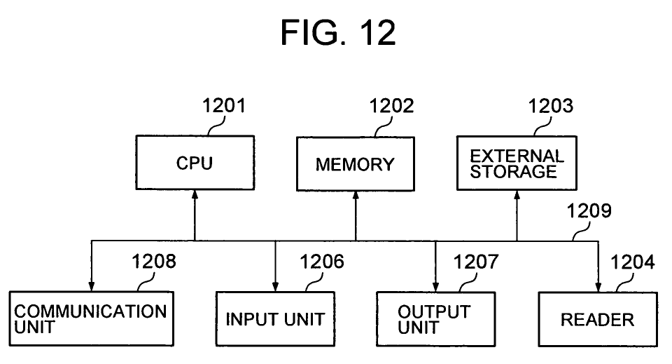

FIG. 12 is a diagram showing an example of a hardware configuration of the monitored object control system 20, the monitoring system 30, or a server in the IT service systems 40. Each system or server is realized when a CPU 1201 executes a program loaded onto a memory 1202 in an ordinary computer that comprises: the CPU 1201; the memory 1202; an external storage 1203 such as an HDD; a reader 1204 for reading data from a storage medium such as a CD-ROM, a DVD-ROM, an IC card or the like; an input unit 1206 such as a keyboard, a mouse, or the like; an output unit 1207 such as a monitor, a printer, or the like; a communication unit 1208 for connecting with a management network 11 or a service network 12; and a bus 1209 for connecting these components. Such a program may be stored or downloaded into the external storage 1203 from a storage medium through the reader 1204 or from the management network 11 or the service network 12 through the communication unit 1208, and then loaded onto the memory 1202 to be executed by the CPU 1201. Or, such a program may be directly loaded onto the memory 1202 without through the external storage 1203, and executed by the CPU 1201.

Each IT service system 40 comprises a load balancer 41, a DB server 44 and a plurality of Web servers 42 and 43, and is connected to information communication devices 13 of customers and the like through the service network 12. Each IT service system 40 has a business application running in it, and returns a response to a request from an information communication device 13, for example, to offer service such as on-line ticket selling for users of information communication devices 13. Further, each IT service system 40 is connected to the monitored object control system 20 and the monitoring system 30 through the management network 11.

The configuration of each IT service system 40 is not limited to the one shown in the figure. Any configuration may be employed as long as it offers service for the information communication devices 13 of customers and the like through the service network 12. Further, each IT service system 40 may be one apparatus or a system as a combination of a plurality of apparatuses. Further, each information communication device 13 is not limited to an information communication terminal, and may be a server or the like. Further, the management network 11 and the service network 12 may be physically different networks from each other, or logically different networks that are physically the same network.

The monitoring system 30 comprises a response time monitoring unit 31, a CPU utilization monitoring unit 32 and a disk utilization monitoring unit 33, and is connected to the monitored object control system 20 and each IT service system 40 through the management network 11. The monitoring system 30 monitors the state of each IT service system 40. And, each time when a significant change occurs in the state of an IT service system 40, the monitoring system 30 sends an event message indicating contents of the change to the monitored object control system 20 through the management network 11.

The response time monitoring system 31 monitors the response time of each IT service system 40 at all times, observing whether a response to a request from an information communication device 13 is returned within a predetermined time (for example, 10 seconds). In the case where a large number of requests come from information communication devices 13 and a processing load on an IT service system 40 increases so that the IT service system 40 can not return a response within the predetermined time, then the response time monitoring system 31 sends an event message to the monitored object control system 20 through the management network 11 to the effect that the state of the IT service system 40 has transitioned from the state where a response time is less than 10 seconds to the state where a response time is more than or equal to 10 seconds. Then, when it becomes possible that the IT service system 40 returns a response within the predetermined time, the response time monitoring unit 31 sends an event message to the monitored object control system through the management network 11 to the effect that the state of the IT service system 40 has transitioned from the state where a response time is more than or equal to 10 seconds to the state where a response time is less than 10 seconds.

Similarly to the response time monitoring unit 31, the CPU utilization monitoring unit 32 and the disk utilization monitoring unit 33 monitor respective parameters such as the CPU utilization and the disk utilization indicating the state of an IT service system 40. When an IT service system 40 comes to be in a state where a parameter concerned becomes higher or lower than a predetermined threshold, the CPU utilization monitoring unit 32 or the disk utilization monitoring unit 33 sends an event message to the monitored object control system 20 through the management network 11 to the effect that the state of the IT service system 40 has transitioned.

Items monitored by the monitoring system 30 are not limited to the response time, the CPU utilization and the disk utilization, and may include the number of cases processed per unit of time, for example. Further, in the present embodiment, the monitoring system 30 is realized as an apparatus separate from each IT service system 40. However, the present invention is not limited to this. For example, the monitoring system 30 may be realized within each IT service system 40 as a part of the functions of the IT service system 40. The other functions of the monitoring system 30 are same as ones of an ordinary monitoring system in an IT management system and detailed description of those functions will be omitted.

The monitored object control system 20 is connected to the monitoring system 30 and the IT service systems 40 through the management network 11. The monitored object control system 20 receives an event message from the monitoring system 30 and controls each IT service system 40 according to the received event message. Here, the control performed by the monitored object control system 20 according to an event message may be as follows. That is to say, when an event message is received from the monitoring system 30 to the effect that the CPU utilization of the Web server 42a exceeds a predetermined threshold, then the load balancer 41a is controlled so as to change the load distribution ratio in the case where the CPU utilization of the Web server 43a leaves a margin, or a new Web server is added so as to expand the load distribution and to reduce the load in the case where no Web server leaves a margin of the CPU utilization. The control according to an event message includes processing for improving the level of service provided to customers, processing for saving the quantity of resource used by a business application, and the like. These are ordinary controls that can be performed in an IT management system, and detailed description of them will be omitted.

The monitored object control system 20 comprises an event message supply unit 21, an event message queue 22, an event log collection unit 24, and a plurality of event processing systems 23a-23c. Each of the event processing systems 23a-23c performs processing corresponding to an event message. For example, with respect to an event message indicating deterioration of a response time, the event processing system 23a makes a spare Web server operate newly to improve the response time. And, for example, with respect to an event message indicating excess of the CPU utilization of the Web server 42a over the predetermined threshold, the event processing system 23b controls the load balancer 41a so as to change the load distribution ratio in the case where the CPU utilization of the Web server 43a leaves a margin. If no Web server leaves a margin of the CPU utilization, a new Web server is added and the setting of the load balancer 41a is changed to add a destination to which the load is distributed.

The event message queue 22 stores event messages issued from the monitoring system 30, and outputs the stored event messages to the event message supply unit 21 in order of issue. The event message supply unit 21 supplies an event message acquired from the event message queue 22 to the event log collection unit 24 and an event processing systems 23 that is appropriate for processing the event message. The event log collection unit 24 keeps a log of all the event messages stored in the event message queue 22 in order of issue. The function of the event log collection unit 24 is similar to the ordinary function of preserving an event log in the conventional event-driven IT management system, and its detailed description will be omitted here.

Further, the function of the event message queue 22 is similar to the ordinary function of receiving event messages in the conventional event-driven IT management system. The event message queue 22 does not set any limit on the method of holding received event messages or on acquisition of event messages by another unshown functional unit. The event message queue 22 simply retains received event messages temporarily in an ordinary storage unit such as the memory or the like in any queuing order. When another functional unit acquires event messages from the event message queue 22, the event message queue 22 functions such that the functional unit can at least acquire the event messages in order of issue.

As shown in FIG. 1, in the present embodiment, the event message queue 22 is arranged in the monitored object control system 20 at reception of event messages received through the management network 11. The event message queue 22 may be arranged inside the event processing systems 23a-23c. In detail, the event message queue 22 may be implemented as a part of functions of the below-mentioned event message holding unit 233a.

An event message supplied from the monitoring system 30 includes at least an event ID 50 for identifying the event message as shown in FIG. 2. As an example of information held by an ordinary event message, FIG. 2 shows an event issue date 51 and a state transition device ID 52 in addition to an event ID 50. The event issue date 51 and the state transition device ID 52 may be expressed as a part of the event ID 50. Further, instead of the event issue date 51, may be used a serial number indicating order of issue of an event message. Further, as additional information, an event message may include an identifier of the business application running on the monitored IT service system 40 or an identifier of business application's processing that has become the cause of the issue of the event message. The format of an event message is determined depending on implementation of the monitoring system 30 from a conventional one.

As examples of an event message, may be mentioned: CPU utilization monitoring event messages; disk utilization monitoring event messages; response time monitoring event messages; and other event messages corresponding to functions of the monitoring system 30. From an event ID 50, the monitored object control system 20 can identify at least a combination of a monitored item (such as the CPU utilization or the like) and a monitored value (such as a threshold of the upper limit 70% or the like) uniquely.

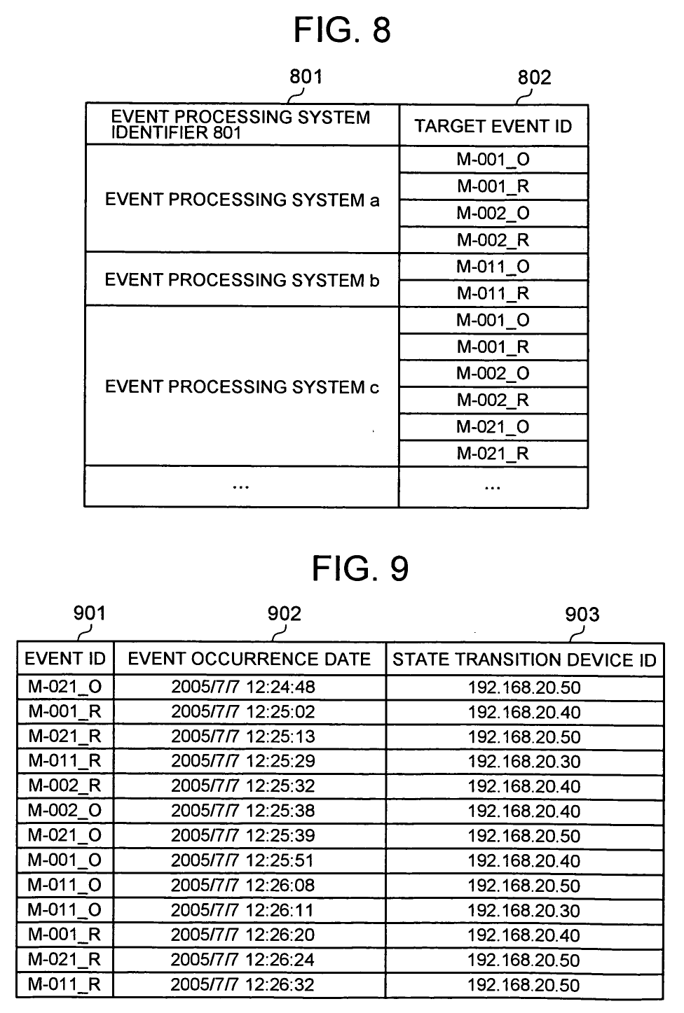

The event message supply unit 21 stores a table (FIG. 8) for specifying an ID of an event message to be supplied to each event processing system 23a-23c. Based on the table, the event message supply unit 21 supplies an event message acquired from the event message queue 22 to an event processing system 23a-23c.

FIG. 8 shows an example of the event message supply table held by the event message supply unit 21, showing correspondence between an event message and an event processing system 23. An event processing system identifier 801 is an identifier used in the monitored object control system 20 for identifying each of the plurality of event processing systems 23 provided in the monitored object control system 20. Contents of control of a monitored object are different between these event processing systems 23. Accordingly, these event processing systems deal with respective event messages of different event IDs. A target event ID 802 shows an event ID that becomes a target of the corresponding event processing system. For example, the figure shows that the event processing system 23a deals with M-001_O, M-001_R, M-002_O and M-002_R as its target event IDs 802. Based on this, the event message supply unit 21 can supply event messages of these event IDs in the event message queue 22 to the corresponding event processing system 23a.

The information indicating the correspondence between an event message and an event processing system 23 is defined by a user of the monitored object control system 20 or by another IT management system arranged in the outside. It is sufficient that the information is provided to the event message supply unit 21 before activation of the monitored object control system 20. Various cases may be considered with respect to the correspondence between an event processing system 23 and an event ID. For example, it is considered that one event ID is dealt with by a plurality of event processing systems 23. In that case, the event message supply unit 21 reproduces an event message of that event ID and supplies the respective event messages to the event processing systems 23 concerned.

FIG. 12 is a diagram showing an example of a hardware configuration of the monitored object control system 20. As shown in the figure, the monitored object control system 20 of the present embodiment can be realized when a CPU 1201 executes a program loaded onto a memory 1202 in an ordinary computer that comprises: the CPU 1201; the memory 1202; an external storage 1203 such as an HDD; a reader 1204 for reading data from a storage medium such as a CD-ROM, a DVD-ROM, an IC card or the like; an input unit 1206 such as a keyboard or a mouse; an output unit 1207 such as a monitor or a printer; a communication unit 1208 for connecting with the management network 11; and a bus 1209 for connecting these components. This program may be stored or downloaded into the external storage 1203 from a storage medium through the reader 1204 or from the management network 11 through the communication unit 1208, and then loaded onto the memory 1202 to be executed by the CPU 1201. Or, the program may be directly loaded onto the memory 1202 without passing through the external storage 1203, and executed by the CPU 1202.

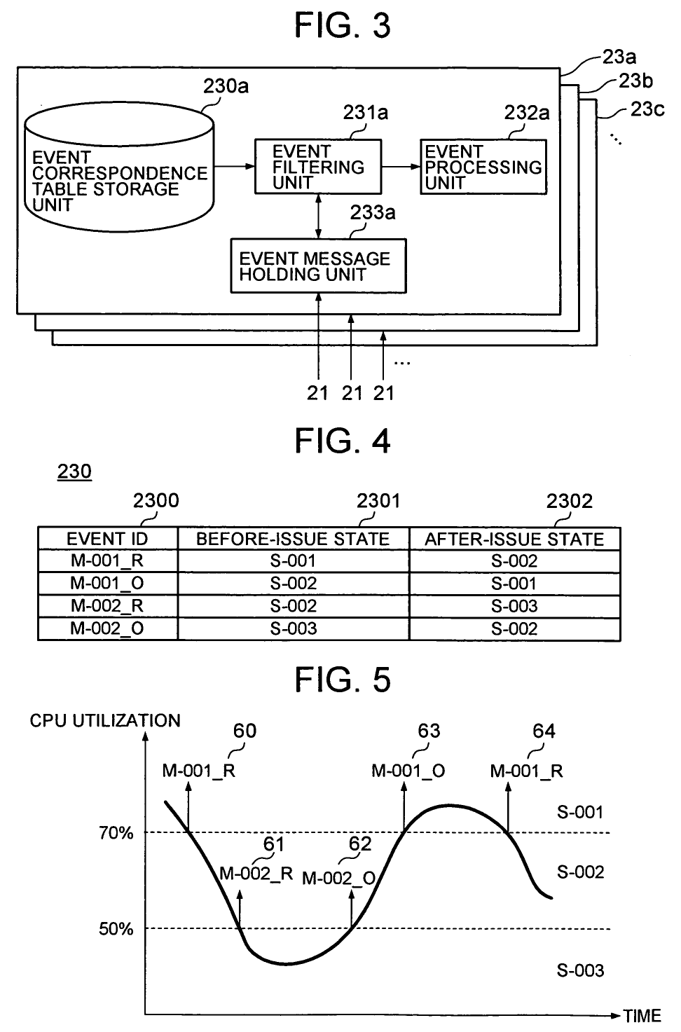

FIG. 3 shows an example of a detailed functional configuration of an event processing system 23. Each event processing system 23 comprises an event correspondence table storage unit 230, an event filtering unit 231, an event processing unit 232 and a event message holding unit 233.

As shown in FIG. 4, the event correspondence table storage unit 230 stores: a before-issue state 2301, i.e. information identifying the state of an IT service system 40 before issue of the event message concerned; and an after-issue state 2302, i.e. information identifying the state of the IT service system 40 after issue of the event message; in association with an event ID 2300, i.e. information identifying the event message.

In the example shown in FIG. 4, with respect to an event message whose event ID 2300 is M-001_R, the before-issue state 2302 is S-001 and the after-issue state is S-002. This shows that an object monitored by some monitoring unit of the monitoring system 30, which has sent the event message M-001_R, has transitioned in its state from S-001 to S-002.

It is possible to define a plurality of states of a monitored object by setting monitoring thresholds with respect to a specific monitored item of the monitored object as described below referring to FIG. 5. Thus, by mechanically giving identifiers to these states, the above identifiers can be determined. It is sufficient that these identifiers indicating states of a monitored object are ones uniquely identifiable in the monitored object control system 20. These identifiers can be determined by the user of the monitored object control system 20 or by another IT management system in the outside. Further, it is sufficient that these identifiers are provided to the event correspondence table storage unit 230 before activation of the monitored object control system 20.

The event message holding unit 233 holds event messages supplied from the event message supply unit 21 in order of issue. The event processing unit 232 controls the IT service systems 40 by processing event messages supplied from the event filtering unit 231.

For example, assuming that the function of the event processing unit 232a is to change the number of Web servers (to which the load is distributed) depending on the CPU utilizations of the Web servers on which a service application is operated, an event message indicating excess of the CPU utilization of a Web server over a predetermined threshold is supplied to the event processing unit 232a through the event filtering unit 231a. Then, the event processing unit 232a executes its processing based on the information of the supplied event message.

Generally, an event message includes either information on the Web server and the service application about which the event message has issued or identifiers necessary for acquiring the required information from a database managing those pieces of information. Based on such information, an unused Web server is specified, and necessity of adding the unused Web server is examined in case of need, and then the Web server is added and settings of the load balancer are changed. Information required for the event processing unit 232 and processing executed in the event processing unit 232 are similar to those of the ordinary event processing functions, and their detailed description will be omitted here.

The event filtering unit 231 refers to event messages in the event message holding unit 233 and the data in the event correspondence table storage unit 230, to extract the state of the IT service system 40 before the issue of the oldest event message in the event message holding unit 233 from the data in the event correspondence table storage unit 230. Then, for each of the second oldest and following event messages, the event filtering unit 231 extracts the state of the IT service system 40 after the issue of the event message in question from the event correspondence table storage unit 230.

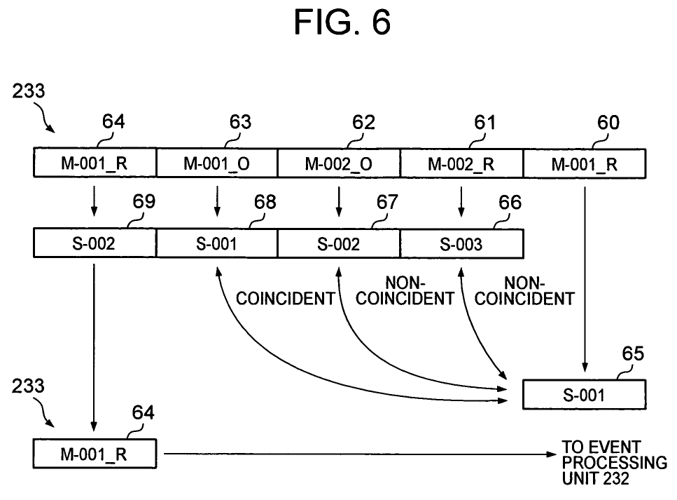

Then, the event filtering unit 231 searches the event message holding unit 233 for an event message for which the state of the IT service system 40 after the issue of that event message coincides with the state of the IT service system 40 before the issue of the oldest event message. Details of the processing will be described below referring to FIG. 6.

In the case where it is not possible to retrieve an event message for which the state of the IT service system 40 after the issue of that event message coincides with the state of the IT service system 40 before the issue of the oldest event message in the event message holding unit 233, the event filtering unit 231 performs event selection processing that selects the oldest event message as an event message to be supplied to the event processing unit 232. Then, when the event processing unit 232 is not in the course of processing, the event filtering unit 231 supplies the event message selected in the event selection processing to the event processing unit 232.

On the other hand, in the case where it is possible to retrieve an event message for which the state of the IT service system 40 after the issue of that event message coincides with the state of the IT service system 40 before the issue of the oldest event message in the event message holding unit 233, the event filtering unit 231 performs delete processing that deletes event messages ranging from the oldest event message to the retrieved event message. The event filtering unit 231 repeats the delete processing until at most one event message remains in the event message holding unit 233 or until the event selection processing is executed.

Referring to FIGS. 5 and 6, the processing of the event filtering processing unit 231 will be described in detail in the following.

As an example, will be described the case where the state of an IT service system 40 transitions because the utilization of the Central Processing Unit (CPU) in the IT service system 40 exceeds or falls below a predetermined threshold, as shown in FIG. 5.

Here, it is assumed that the IT management system dynamically controls quantity of resource assigned to a service application depending on the service level.

For example, CPU utilizations of Web servers arranged in a load distribution configuration are among objects monitored. When the CPU utilization of some Web server exceeds the upper limit 70%, then the IT management system judges that the Web server is in a high load state. Then, the IT management system adds another Web server and changes the settings of the load balancer to distribute the load, attempting reduction of the load of the Web server in question. Inversely, when the CPU utilization of some Web server falls below the lower limit 50%, then the IT management system judges that the Web server is in a low load state. Then, the IT management system change the settings of the load balancer, trims the load, and detaches a surplus Web server. As a result, it is possible to use the computer resources effectively.

In the example shown in FIG. 5, when the state transitions from S-001 where the CPU utilization is 70% or more to S-002 where the CPU utilization is more than or equal to 50% and less than 70%, the monitoring system 30 sends an event 60 to the monitored object control system 20. Thereafter, when the state of the IT service system 40 transitions from S-002 to S-003 where the CPU utilization is less than 50%, the monitoring system 30 sends an event 61 to the monitored object control system 20.

Thereafter, when the state of the IT service system 40 transitions to S-002, S-001 and S-002, the monitoring system 30 respectively sends an event 62, an event 63 and an event 64 to the monitored object control system 20.

FIG. 9 shows a state of the event messages held temporarily in the event message queue 22 in the format shown in FIG. 2. The order in which event message are arranged in the event message queue 22 is not limited specifically. Here, for the sake of convenience, is shown a state in which event messages are arranged in order of event issue date. The event message queue 22 accumulates not only the event messages relating to the CPU utilization shown in FIG. 5 but also various kinds of event messages relating to a plurality of monitored items that can be monitored by the monitoring system 30. The event message supply unit 21 refers to the event message supply table shown in FIG. 8 to supply the event messages from the event message queue 22 to respective event processing systems 23.

Here, it is assumed that the IT management system dynamically changes the quantities of the computer resources assigned to the service applications based on the service levels. For the sake of simplicity, only the event messages relating to the CPU utilization are considered here. Then, in the present embodiment, the event messages 60-64 reach the event processing system 23 in turn.

In the case where these event messages are processed without applying the present invention, the IT management system judges that the system is in a stable state when it receives the event message 60, and thereafter judges that the system is in a low load state when it receives the event message 61 and reduces the Web servers. Then, receiving the event message 62, the IT management system judges that the system is in a stable state. And, receiving the event message 63, the IT management system judges that the system is in a high load state and adds a Web server. When the event message 64 is received, the IT management system judges that the system is in a stable state, and finishes a series of processes.

Thus, in the case where event messages as in the example shown in FIG. 5 are processed one by one without by applying the present invention, deletion and addition of a Web server occur successively in a given period of time, causing wasteful processing when the IT management system is seen as a whole. Actually, addition and deletion of a Web server take a considerable transition time (in minutes or in hours), and, as a result, the Web server addition and deletion processing are late for reception of an event message. Thus, there occurs a discrepancy between the actual states of the managed objects (the IT service systems 40 in the present embodiment) and the states grasped by the IT management system (the monitored object control system 20 in the present embodiment). Thus, the below-described processing in an event processing system 23 is important.

Assuming that the state of the IT service system 40 has transitioned as shown in FIG. 5 while the event processing unit 232 is processing the event message supplied last time (i.e. the event message just before the event message 60), the event messages 60-64 are stored in the event message holding unit 233 as shown in FIG. 6, for example. As for the example shown in FIG. 6, it is assumed, for the sake of simplicity of description, that the event messages are held in the event message holding unit 233 in order of issue. It is sufficient that each of the event messages stored in the event message holding unit 233 is attached with, for example, a number or a time stamp so that the order of issue can be known. It is not necessary that these event messages are stored in order of issue in the message holding unit 233.

Next, the event filtering unit 231 refers to the event correspondence table storage unit 230 to acquire the state 65 before the issue of the oldest event message (the event 60 in FIG. 6) in the event message holding unit 233. This state S-001 is the state before the issue of the event 60, and corresponds to the state where the CPU utilization exceeds 70% in FIG. 5. This state means the state after the receipt of the event message supplied last time. Then, for each of the second oldest and following event messages (the events 61-64 in the example of FIG. 6) in the event message holding unit 233, the event filtering unit 231 acquires the state (each after-issue state 66-69 in the example of FIG. 6) of the IT service system 40 after the issue of the event message in question, by referring to the event correspondence table storage unit 230.

Then, the event filtering unit 231 compares the before-issue state 65 with each of the after-issue states 66-69. In the example shown in FIG. 6, the event filtering unit 231 detects the coincidence between the before-issue state 65 and the after-issue state 68, and deletes the event messages 60-63 corresponding to the before issue state 65 and the after-issue states 66-68 from the event message holding unit 233.

Here, the meaning of deleting the event messages 60-63 will be described referring to FIG. 5. The event messages 60-63 indicate transitions of the state of the monitored object from S-001 to S-002, from S-002 to S-003, from S-003 to S-002, from S-002 to S-001, and from S-001 to S-002, respectively. Since the existing state (i.e. the final state) is S-002, it does not matter from the viewpoint of event processing to treat the state of the CPU utilization as if it transitions directly from S-001 of the initial state 65 (i.e. before the issue of the event message 60) to S-002 of the final state. The system does not need to perform unnecessary processing of increasing and decreasing the computer resources. In other words, the processing for dealing with the intermediate states S-002, S-003, S-002 and S-001 can be omitted. This is equivalent to deletion of the four event messages 60-63 corresponding to the four transition states following the initial state 65, as objects of processing by the event processing unit.

The state after the issue of the event message 60 is S-002. This state is not included in the objects of the coincidence/non-coincidence examination (FIG. 6). The propriety of deleting this state relates to the possibility of deleting the event message 60. This is uniquely determined by separately examining the initial state S-001 of the system before the issue of the event message 60. Thus, it is not necessary to determine in the examination shown in FIG. 6 whether the event message 60 can be deleted or not. Further, usually the state of the system is different between before and after the issue of the event message 60, and thus it is not necessary in the processing of FIG. 6 to examine coincidence/non-coincidence with respect to the state after the issue of the event message 60.

Thereafter, in the example shown in FIG. 6, one event message, i.e. the event message 64, remains in the event message holding unit 233. Accordingly, the event filtering unit 231 judges that further deletion of an event message is not necessary, and selects the remaining event message 64 as an event message to be supplied next time to the event processing unit 232. In the case where a plurality of event messages remain in the event message holding unit 233 after the deletion of the event messages, the event filtering unit 231 performs again the processing of searching the remaining event messages in the event message holding unit 233 for an event message for which the state of the IT service system 40 after the issue of that event message coincides with the state of the IT service system 40 before the issue of the oldest event message in the event message holding unit 233.

Thus, in the case where an event message is issued owing to transition of the state of the IT service system 40, but, before performing the processing corresponding to that event message, the state of the IT service system 40 has transitioned to the state before the issue of that event message, then the event processing system 23 does not perform the processing corresponding to event messages issued in the mean time. As a result, the event processing system 23 can rapidly process many event messages issued in a short time, and certainly perform control of the IT service system 40, which should be performed correspondingly to each event message.

In the IT management system that dynamically changes the computer resources assigned to the business applications depending on their service levels, it is possible to suppress wasteful processing corresponding to the event messages 61 and 63. Further, it is possible to eliminate unnecessary Web server addition/deletion processing that takes a long time.

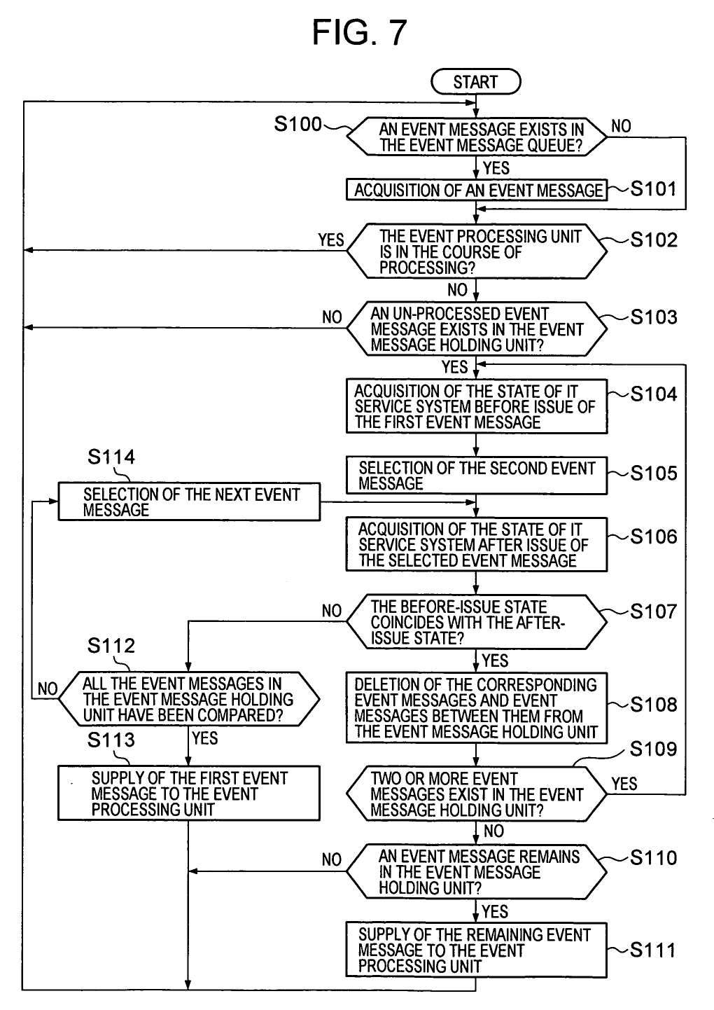

FIG. 7 is a flowchart showing an example of operation of the monitored object control system 20. For example, when the monitored object control system 20 is activated, the monitored object control system 20 starts the processing shown in the flowchart. In the following, for the sake of simplicity of description, it is assumed that there exists one event processing system 23.

First, the event message supply unit 21 judges whether the event message queue 22 stores an event message or not (S100). In the case where no event message is stored in the event message queue 22 (S100: No), the event filtering unit 231 performs the processing of the step S102.

In the case where an event message is stored in the event message queue 22 (S100: Yes), the event message supply unit 21 acquires event messages from the event message queue 22. Then, referring to the respective event IDs of the acquired event messages, the event message supply unit 21 supplies these event messages in order of issue to the event processing system 23 that processes these event messages. The event holding unit 233 in the event processing system 23 acquires and holds the event messages supplied from the event message supply unit 21 (S101).

Next, the event filtering unit 231 judges whether the event processing unit 232 is in the course of processing an event message or not (S102). In the case where the event processing unit 232 is in the course of processing an event message (S102: Yes), the event message supply unit 21 performs the processing of the step S100 again.

In the case where the event processing unit 232 is not in the course of processing an event message (S102: No), the event filtering unit 231 judges whether there exists an unprocessed event message in the event message holding unit 233 (S103). In the case where an unprocessed event message does not exist in the event message holding unit 233 (S103: No), the event message supply unit 21 performs the processing of the step S100 again.

The above steps S100-S101 are processing steps for an embodiment having the event message queue 22, and are essentially processing of awaiting notification of an event message from the monitoring system 30.

In an embodiment without having the event message queue 22, when the monitored object control system 20 receives an event message from the monitoring system 30, the event message supply unit 21 supplies the received event message to the event processing system 23, and the steps starting with S102 are performed while the steps S100-S101 are omitted. Details of this method depend on a method of implementing the processing of the monitored object control system 20 for receiving an event message.

The present invention can be applied irrespective of existence or nonexistence of the event message queue 22, and is effective in either case.

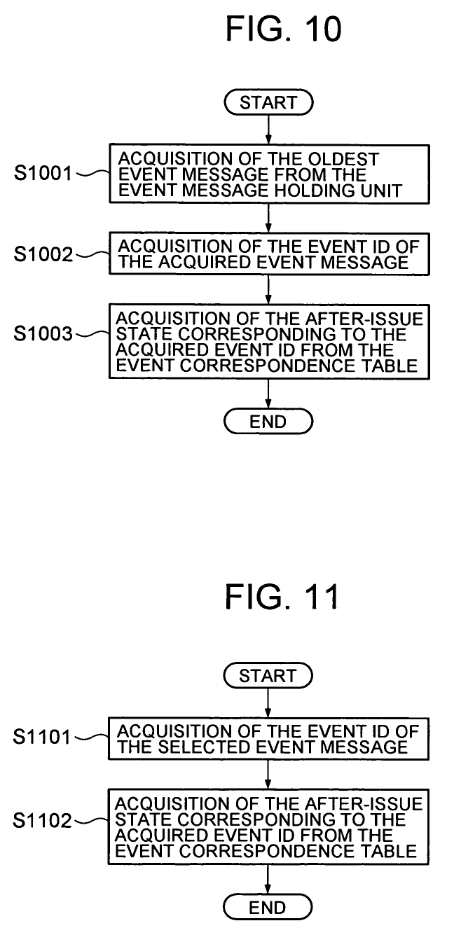

In the case where an unprocessed event message exists in the event message holding unit 233 (S103: Yes), the event filtering unit 231 acquires the state before the issue of the oldest event message in the event message holding unit 233 from the event correspondence table storage unit 230 (S104). Then, the event filtering unit 231 selects the second oldest event message (S105), and acquires the state after the issue of the selected event message from the event correspondence table storage unit 230 (S106). FIG. 10 is a flowchart showing details of S104, and FIG. 11 shows details of S106.

In the step (S104 in FIG. 7) where the state of the IT service system 40 before the issue of the oldest event message is acquired, the monitored object control system 20 acquires the oldest event message from the event message holding unit 233 (S1001 in FIG. 10), acquires the event ID from the event message (S1002), and acquires the after-issue state corresponding to the acquired event ID from the event correspondence table (FIG. 4) stored in the event correspondence table storage unit 230 (S1003).

In the step (S106 in FIG. 7) where the state of the IT service system 40 after the issue of the selected event message is acquired, the monitored object control system 20 acquires the event ID from the selected event message (S1101 in FIG. 11), and acquires the after-issue state corresponding to the acquired event ID from the event correspondence table (FIG. 4) stored in the event correspondence table storage unit 230 (S1102).

The monitored object control system 20 acquires the before-issue state 65, i.e. S-001, (FIG. 6) of the event message 60 corresponding to M-001_R in the step S104 (FIG. 7), and acquires the state 66, i.e. S-003, after the issue of the second oldest event message 61 corresponding to M-002_R in the step S105.

Next, the event filtering unit 231 judges whether the before-issue state acquired in the step S104 coincides with the after-issue state acquired in the step S106 (S107). In the case where the before-issue state acquired in the step S104 coincides with the after-issue state acquired in the step S106 (S107: Yes), the event filtering unit 231 deletes, from the event message holding unit 233, the oldest event message in the event message holding unit 233, the event message for which the after-issue state coincides with the before-issue state acquired in the step S104, and the event messages issued between these event messages (S108).

In the third processing of the step S107, the state 65 (FIG. 6) before the issue of the event message 60, which is acquired in the step S104, coincides with the state 68 after the issue of the event message 63, which is acquired in the step S106. As a result, the judgment in the step S107 is “Yes” and the event messages 60-63 are deleted (S108).

Next, the event filtering unit 231 judges whether two or more event messages remain in the event message holding unit 233 (S109). In the case where two or more event messages remain in the event message holding unit 233 (S109: Yes), the event filtering unit 231 performs the processing of the step S104 again.

In the example of FIG. 6, the event messages 60-63 are deleted in the step S108, and only the event message 64 remains in the event message holding unit 233. If two or more event messages remain as a result of deletion in the step S108, the steps are repeated from S104 to find an event message that can be deleted furthermore (S109).

In the case where two or more event messages do not remain in the event message holding unit 233 (S109: No), the event filtering unit 231 judges whether an event message remains in the event message holding unit 233 (S111). In the case where no event message remains in the event message holding unit 233 (S110: No), the event message supply unit 21 performs the processing of the step S100 again. In the case where an event message remains in the event message holding unit 233 (S110: Yes), the event filtering unit 231 supplies the remaining event message to the event processing unit 232 (S111), and the event message supply unit 21 performs the processing of the step S100 again.

In the example of FIG. 6, the event messages 60-63 are deleted in the step S108, and only the event message 64 remains in the event message holding unit 233. Accordingly, the judgment in the step S109 is “No” and the judgment in the step S110 is “Yes”, and the event filtering unit 231 supplies the event message 64 to the event processing unit 232 in the step S111. The monitored object control system 20 always makes the judgment of the step S109 before the step S111. Thus, whenever the judgment in the step S110 is “Yes”, one event message remains in the event message holding unit 233.

In the case where the before-issue state acquired in the step S104 does not coincide with the after-issue state acquired in the step S106 (S107: No), the event filtering unit 231 judges whether the comparison processing of the step S107 has been performed for all the event messages in the event message holding unit 233 except for the oldest event message (S112).

In the example of FIG. 6, this is comparison of the state 65 (which is acquired in the step S104 (FIG. 7)) of the IT service system before the issue of the oldest event message with the after-issue states 66-67 acquired in the step S106. The state 66 after the issue of the event message 61 is S-003, which is acquired in the step S106 first time. As a result of comparison, this state 66 (S-003) does not coincide with the state 65 (S-001) before the issue of the oldest event message, and thus the judgment of the step S107 is “No” and the flow proceeds to the next step.

In the case where the comparison processing of the step S107 has been performed for all the event messages in the event message holding unit 233 except for the oldest event message (S112: Yes), the event filtering unit 231 supplies the oldest event message in the event message holding unit 233 to the event processing unit 232 (S113), and the event message supply unit 21 performs the processing of the step S100 again.

In other words, when an after-issue state coincident with the state 65 (S-001 in FIG. 6) before the issue of the oldest event message is not found (S107: No in FIG. 7) and the processing of all the event message has been finished (S112: Yes), then the monitored object control system 20 supplies the oldest event message 60 to the event processing unit 232.

In the case where the comparison processing of the step S107 has not been performed for all the event messages in the event message holding unit 233 except for the oldest event message (S112: No), the event filtering unit 231 selects the next event message (S114) and performs the processing of the step S106 again.

As obvious from the above description, according to the event processing system 23 of the present embodiment, it is possible to perform certainly processing corresponding to event messages and to improve the efficiency of processing event messages. In other words, when the present invention is applied to an event-driven IT management system, it is possible to prevent a discrepancy between the actual state of a managed object and the state grasped by the IT management system and to avoid unnecessary processing for coping with the discrepancy.

Particularly, in an IT management system in which computer resources assigned to service applications are dynamically changed depending on their service levels, it is possible to omit unnecessary and time-consuming processing such as successive addition and deletion of a computer resource.

Hereinabove, an embodiment of the present invention has been described. However, the embodiment does not limit the technical scope of the present invention. Further, it is obvious for a person skilled in the art that the above-described embodiment can be variously modified and improved. Further, it is obvious from the attached claims that the scope of the invention includes such modifications and improvements.

1. An event processing system that receives, each time when a state of a monitored system makes a transition, an event message specifying a content of said transition from a monitoring system, and controls said monitored system according to the received event message, wherein:
said event processing system comprises:
an event message holding means, which holds event messages issued by said monitoring system and outputs said event messages in order of issue;
an event processing means, which processes the event messages outputted from said event message holding means, to control said monitored system; and
an event filtering means, which selects event messages to be processed among the event messages in said event message holding means and supplies the selected event messages to said event processing means; and
said event filtering means searches the event messages held in said event message holding means for an event message for which a state of said monitored system after issue of said event message coincides with a state of said monitored system before issue of an oldest event message stored in said event message holding means; and
when said event filtering means can retrieve the event message in question, the event filtering means performs filtering processing by deleting event messages ranging from the oldest event message to the retrieved event message from said event message holding means.

2. An event processing system according to claim 1, wherein:
with respect to n event messages held in said event message holding means, when said event filtering means can retrieve a k-th (1<k<=n) event message, for which a state of the monitored system after issue of said k-th event message coincides with a state of the monitored system before issue of the oldest event message stored in the event message holding means, then said event filtering means deletes event messages ranging from the oldest event message to the k-th event message from said event message holding means, and performs said filtering processing again with respect to event messages remaining in the event message holding means.

3. An event processing system according to claim 1, wherein:
said event filtering means performs said filtering processing when said event processing means finishes processing of event messages supplied last time.

4. An event processing according to claim 1, wherein:
each of said event messages includes at least an event identifier that identifies the event message in question;
said event processing system further comprises an event correspondence table storage means, which stores, in association with an event identifier of each event message, a before-issue state indicating a state of said monitored system before issue of said event message and an after-issue state indicating a state of the monitored system after issue of said event message; and
based on an event identifier of an event message in said event message holding means, said event filtering means refers to said event correspondence table storage means to acquire a state of said monitored system before issue of said event message and a state of said monitored system after issue of said event message.

5. An event processing method in an event processing system that receives, each time when a state of a monitored system makes a transition, an event message specifying a content of said transition from a monitoring system, and controls said monitored system according to the received event message, wherein:
said event processing system performs:
a step of holding an event message issued from said monitoring system in an event message holding means;
a step of searching for an event message for which a state of said monitored system after issue of said event message coincides with a state of said monitored system before issue of an oldest event message stored in said event message holding means, among event messages held in said event message holding means; and
a step of deleting, from said event message holding means, event messages ranging from said oldest event message to the retrieved event message in question when the event processing system can retrieve said event message.

6. An event processing method in an event processing system that receives, each time when a state of a monitored system makes a transition, an event message specifying a content of said transition from a monitoring system, and controls said monitored system according to the received event message, wherein:
said event processing system performs:
a first step in which event messages issued from said monitoring system are held in an event holding means;
a second step in which, with respect to n event messages held in said event message holding means, a k-th (1<k<=n)) event message, for which a state of the monitored system after issue of said k-th event message coincides with a state of the monitored system before issue of an oldest event message stored in said event message holding means, is searched for;
a third step in which, when the event processing system can retrieve the k-th event message in the second step, the event processing system deletes event messages ranging from said oldest event message to said k-th event message from said event message holding means; and
a fourth step in which said first step through said third step are repeated with respect to event messages remaining in said event message holding means.

7. An event processing method according to claim 6, wherein:
when said event processing system can not retrieve an event message for which a state of said monitored system after issue of said event message coincides with the state of said monitored system before issue of said oldest event message, then said event processing system performs, in said third and fourth steps, a fifth step in which said monitored system is controlled according to an oldest event message remaining in said event message holding means.

8. An event processing apparatus that receives, each time when a state of a monitored system makes a transition, an event message specifying a content of said transition from a monitoring system, wherein:
said event processing apparatus comprises:
an event message holding unit that holds event messages issued by said monitoring system and outputs said event messages in order of issue;
an event processing unit that processes the event messages outputted from said event message holding unit, to control said monitored system; and
an event filtering unit that selects event messages to be processed among the event messages in said event message holding unit and supplies the selected event messages to said event processing unit; and
with respect to n event messages held in said event message holding unit, said event message filtering unit searches for a k-th (1<k<=n) event message, for which a state of the monitored system after issue of said k-th event message coincides with a state of said monitored system before issue of an oldest event message stored in said event message holding unit; and
when the event message filtering unit can retrieve said k-th event message, the event message filtering unit performs filtering processing by deleting event messages ranging from said oldest event message to said k-th event message from said event message holding unit.

9. An event processing apparatus according to claim 8, wherein:
in a case where event messages remain in said event message holding unit after last filtering processing is finished, said event filtering unit repeats said filtering processing with respect to said remaining event messages.

10. An event processing apparatus according to claim 8, wherein:
in a case where said event filtering unit can not retrieve an event message for which a state of the monitored system after issue of said event message coincides with the state of the monitored system before issue of said oldest event message, said event filtering unit ends said filtering processing and supplies an oldest event message among event messages remaining in said event message holding unit to said event processing unit.

11. An event processing unit according to claim 8, wherein:
in a case where one event message remains in said event message holding unit when said event processing unit finishes processing of an event message supplied last time, said event filtering unit performs said filtering processing with respect to said remaining event message.

12. A storage medium storing an event processing program that makes an event processing apparatus operate such that said event processing apparatus receives, each time when a state of a monitored system makes a transition, an event message specifying a content of said transition from a monitoring system and controls said monitored system according to the received event message, wherein:
said event processing program comprises:
an event message holding module that holds event messages issued by said event monitoring system and outputs said event messages in order of issue;
an event processing module that processes the event messages outputted from said event message holding module, to control said monitored system; and
an event filtering module that selects event messages to be processed among the event messages held by said event message holding module and supplies the selected event messages to said event processing module; and
with respect to n event messages held by said event message holding module, said event message filtering module searches for a k-th (1<k<=n) event message, for which a state of the monitored system after issue of said k-th event message coincides with a state of said monitored system before issue of an oldest event message stored by said event message holding module; and
when the event message filtering module can retrieve said k-th event message, the event message filtering module performs filtering processing by deleting event messages ranging from said oldest event message to said k-th event message from said event message holding module.

13. A storage medium storing an event processing program according to claim 12, wherein:
in a case where event messages remain in said event message holding module after last filtering processing is finished, said event filtering module repeats said filtering processing with respect to said remaining event messages.

14. A storage medium storing an event processing program according to claim 12, wherein:
in a case where said event filtering module can not retrieve an event message for which a state of the monitored system after issue of said event message coincides with the state of the monitored system before issue of said oldest event message, said event filtering module ends said filtering processing and supplies an oldest event message among event messages remaining in said event message holding module to said event processing module.

15. A storage medium storing an event processing program according to claim 12, wherein:
in a case where one event message remains in said event message holding module when said event processing module finishes processing of an event message supplied last time, said event filtering module performs said filtering processing with respect to said remaining event message.
